(19) United States
(12) Patent Application Publication
(10) Pub. No.: US 2026/0112790 A1
(43) Pub. Date: Apr. 23, 2026

(54) CURRENT COLLECTOR AND BATTERY

(71) Applicant: TOYOTA JIDOSHA KABUSHIKI KAISHA, Toyota-shi (JP)

(72) Inventors: Ryuto SAKAMOTO, Okazaki-shi (JP); Tetsuya MIMURA, Chiryu-shi (JP); Atsushi SUGIHARA, Toyota-shi (JP); Satoshi MORIYAMA, Nagoya-shi (JP); Masayoshi HAGA, Nagoya-shi (JP); Masaki FURUKAWA, Toyota-shi (JP); Keita YAMASHITA, Nagoya-shi (JP); Hideyuki NAGAI, Nagoya-shi (JP)

(73) Assignee: TOYOTA JIDOSHA KABUSHIKI KAISHA, Toyota-shi (JP)

(21) Appl. No.: 19/230,566

(22) Filed: Jun. 6, 2025

(30) Foreign Application Priority Data
Oct. 17, 2024 (JP) 2024-181988

(51) Int. Cl. H01M 50/536; H01M 4/66; H01M 10/653; H01M 50/538

(52) U.S. Cl. CPC H01M 50/536; H01M 4/667; H01M 10/653; H01M 50/538

(57) ABSTRACT

A current collector includes a support layer, a conductive layer, an adhesive layer, and a tab. The support layer is made of an electrically insulating resin composition. The conductive layer includes a body portion and an extension portion. The body portion is laminated on the support layer via the adhesive layer. The extension portion extends from the body portion. The extension portion is laminated on the support layer not via the adhesive layer. The tab is joined to the extension portion.

### CROSS-REFERENCE TO RELATED APPLICATION

This application claims priority to Japanese Patent Application No. 2024-181988 filed on Oct. 17, 2024. The disclosure of the above-identified application, including the specification, drawings, and claims, is incorporated by reference herein in its entirety.

### BACKGROUND

### 1. Technical Field

The present disclosure relates to a current collector and a battery.

### 2. Description of Related Art

Japanese Unexamined Patent Application Publication (Translation of PCT Application) No. 2024-510696 (JP 2024-510696 A) discloses a conventional electrode plate. The electrode plate includes a current collector, an active material layer, and an electrical connection member. The current collector includes a support layer and a conductive layer. The support layer is made of an insulating material. The conductive layer is disposed on one surface of the support layer. The electrical connection member and the current collector are connected by welding at the edge of the current collector. JP 2024-510696 A further discloses that a mixed solution of PVDF and NMP is applied to the surface of the support layer, and bonds the conductive layer having a predetermined thickness to the surface of the support layer.

### SUMMARY

An adhesive layer between a conductive layer and a support layer can adversely affect the bonding strength between the conductive layer and a tab (electrical connection member).

The present disclosure has been made in consideration of the above issue, and aims to provide a current collector and a battery that can reduce the effect of the adhesive layer between the conductive layer and the support layer on the bonding strength between the conductive layer and the tab.

A current collector according to an aspect of the present disclosure includes a support layer, a conductive layer, an adhesive layer, and a tab. The support layer is made of an electrically insulating resin composition. The conductive layer includes a body portion and an extension portion. The body portion is laminated on the support layer via the adhesive layer. The extension portion extends from the body portion. The extension portion is laminated on the support layer not via the adhesive layer. The tab is joined to the extension portion.

A battery according to an aspect of the present disclosure includes an electrode body and an external terminal. The electrode body includes a first electrode, a second electrode, and a separator. The first electrode includes a current collector and an active material layer. The current collector includes a support layer, a conductive layer, an adhesive layer, and a tab. The support layer is made of an electrically insulating resin composition. The conductive layer includes a body portion and an extension portion. The body portion is laminated on the support layer via the adhesive layer. The extension portion extends from the body portion. The extension portion is laminated on the support layer not via the adhesive layer. The tab is joined to the extension portion. The active material layer is laminated on the body portion. The separator is laminated on the active material layer. The second electrode is laminated on the active material layer via the separator. The external terminal is electrically connected to the tab.

According to the present disclosure, the effect of the adhesive layer between the conductive layer and the support layer on the bonding strength between the conductive layer and the tab can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view illustrating a battery according to an embodiment;

FIG. 2 is a cross-sectional view of an electrode body in FIG. 1, taken along line II-II;

FIG. 3 is a deployed view of a first electrode according to the embodiment; and

FIG. 4 is a partial sectional view of the first electrode in FIG. 3, taken along line IV-IV.

### DETAILED DESCRIPTION OF EMBODIMENTS

Hereinafter, a current collector and a battery according to an embodiment of the present disclosure will be described with reference to the drawings. The same reference signs are given to the same or equivalent portions in the drawings, and the description of such portions will not be repeated.

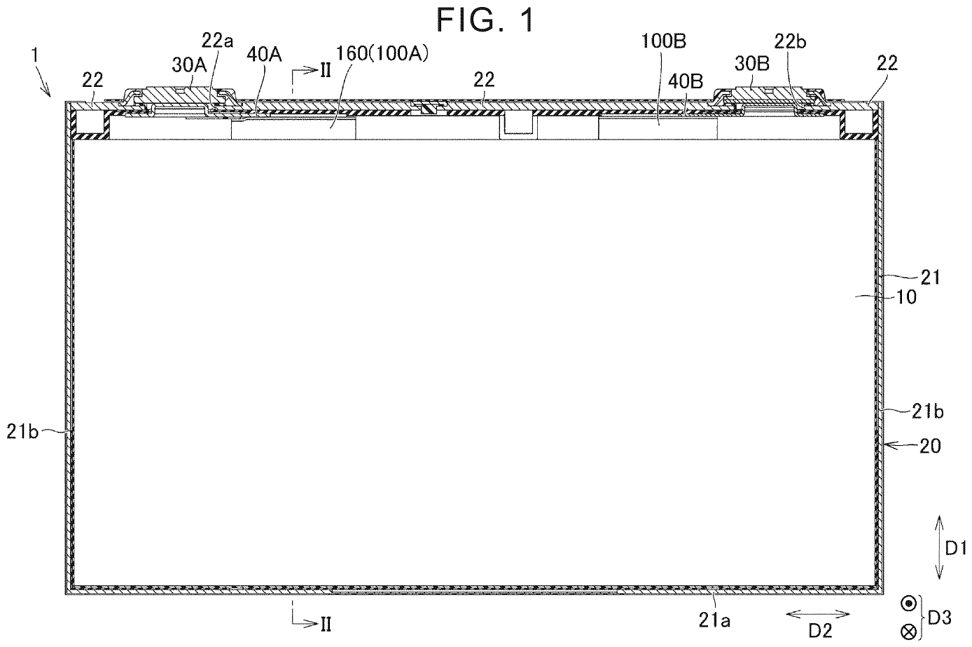

FIG. 1 is a sectional view illustrating the battery according to the embodiment. A battery 1 shown in FIG. 1 is a so-called prismatic battery. The battery 1 may be a secondary battery configured to be capable of charging and discharging, such as a lithium ion battery, and a nickel metal hydride battery. The battery 1 can be used, for example, as a cell included in a power storage module mounted on an electrified vehicle.

As shown in FIG. 1, the battery 1 according to the embodiment of the present disclosure includes an electrode body 10, a case 20, a first external terminal 30A, a second external terminal 30B, a first connecting member 40A, and a second connecting member 40B. First, configurations of components of the battery 1 other than the electrode body 10 will be described.

The case 20 is conductive. A conductive portion of the case 20 is made of a metal, such as aluminum. The case 20 houses the electrode body 10. The case 20 also houses an electrolyte (not shown).

The case 20 includes a case body 21 and a lid 22. The case body 21 includes a bottom wall 21a and a peripheral wall 21b standing upright from the bottom wall 21a.

The lid 22 is joined to the peripheral wall 21b, such as by welding, so as to close an opening of the peripheral wall 21b. The lid 22 has a first connecting hole 22a and a second connecting hole 22b.

The first external terminal 30A and the second external terminal 30B are provided in the battery 1 so as to be exposed to the outside. The first connecting member 40A and the second connecting member 40B are conductive. At least a portion of the first connecting member 40A and at least a portion of the second connecting member 40B are disposed inside the case 20.

The first external terminal 30A or the first connecting member 40A is inserted into the first connecting hole 22a. The first external terminal 30A is electrically connected to the first connecting member 40A. Specifically, the first external terminal 30A and the first connecting member 40A are joined to each other. The first connecting member 40A is joined to the electrode body 10. Accordingly, the first external terminal 30A is electrically connected to the electrode body 10.

The second external terminal 30B or the second connecting member 40B is inserted into the second connecting hole 22b. The second external terminal 30B is electrically connected to the second connecting member 40B. Specifically, the second external terminal 30B and the second connecting member 40B are joined to each other. The second connecting member 40B is joined to the electrode body 10. Accordingly, the second external terminal 30B is electrically connected to the electrode body 10.

In the embodiment, the first external terminal 30A is a cathode terminal, and the second external terminal 30B is an anode terminal. The first external terminal 30A and the second external terminal 30B are arranged in a second direction D2. The second direction D2 is a direction orthogonal to a first direction D1.

Next, the electrode body 10 will be described. The battery 1 according to the embodiment includes a plurality of the electrode bodies 10. The battery 1 typically includes two electrode bodies 10. These electrode bodies 10 are arranged in a third direction D3. The third direction D3 is a direction orthogonal to both the first direction D1 and the second direction D2.

In the following, one of the electrode bodies 10 will be described. Each of the electrode bodies 10 may have the configuration shown below.

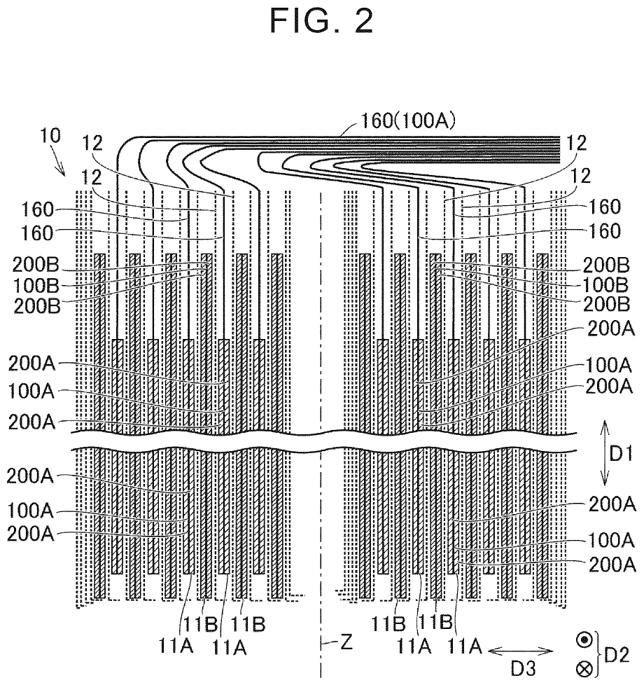

FIG. 2 is a cross-sectional view of the electrode body in FIG. 1, taken along line II-II. As shown in FIGS. 1 and 2, the electrode body 10 includes a first electrode 11A, a second electrode 11B, and separators 12. In the electrode body 10, the first electrode 11A, the second electrode 11B, and the separators 12 are wound to surround a winding axis Z. Thus, in the embodiment, the electrode body 10 is a so-called wound electrode body. However, the electrode body 10 may be a stacked electrode body in which the first electrodes 11A, the second electrodes 11B, and the separators 12 are stacked in one direction (for example, the third direction D3). In FIG. 2, the separators 12 are schematically represented by dashed lines.

The first electrode 11A and the second electrode 11B have a sheet-like outer shape. The electrode body 10 includes an electrode plate group in which the first electrode 11A and the second electrode 11B are wound with one or more separators 12 interposed therebetween. In the embodiment, the first electrode 11A is a cathode, and the second electrode 11B is an anode. However, the first electrode 11A may be an anode and the second electrode 11B may be a cathode.

The separators 12 are provided between the first electrode 11A and the second electrode 11B. The separators 12 separate the first electrode 11A from the second electrode 11B while allowing ions to travel between the first electrode 11A and the second electrode 11B. The ions are, for example, lithium ions. The separators 12 have electrical insulation properties.

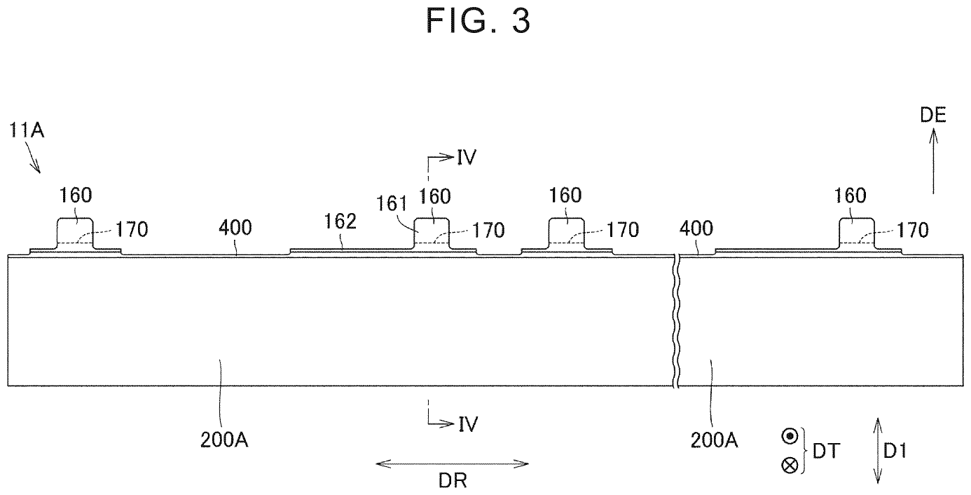

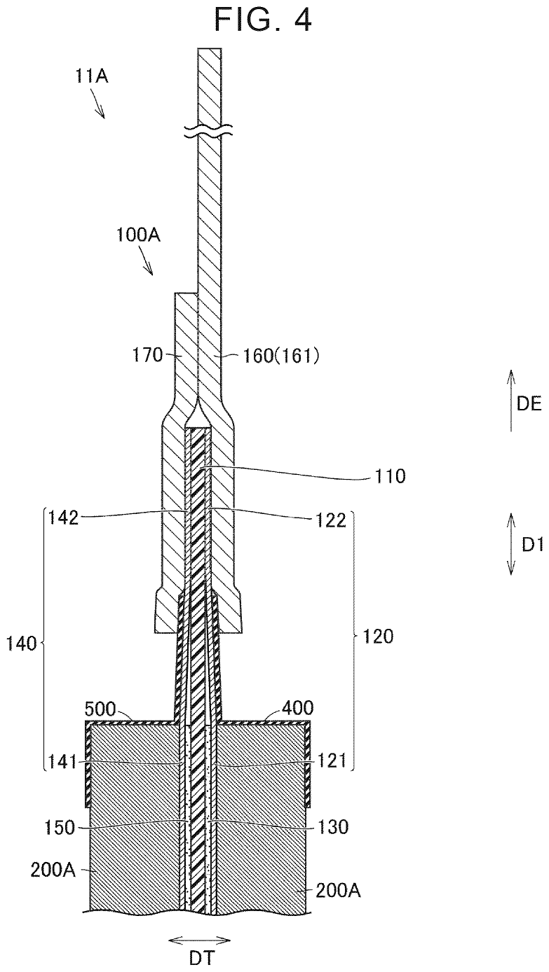

FIG. 3 is a deployed view of the first electrode 11A according to the embodiment. That is, FIG. 3 shows the state before the first electrode 11A is wound. FIG. 4 is a partial sectional view of the first electrode 11A in FIG. 3, taken along line IV-IV.

As shown in FIGS. 2 to 4, the first electrode 11A includes a first current collector 100A, a pair of first active material layers 200A, a first protective portion 400, and a second protective portion 500.

As shown in FIG. 4, the first current collector 100A includes a support layer 110, a first conductive layer 120, a first adhesive layer 130, a second conductive layer 140, a second adhesive layer 150, a plurality of tabs 160, and a plurality of conductive auxiliary portions 170.

The support layer 110 is made of an electrically insulating resin composition. Therefore, the first current collector 100A is a composite current collector made up of a conductive member and an electrically insulating member. This makes the first current collector 100A lighter than when the first current collector 100A is made entirely of metal, and this also improves the safety of the battery 1 as a whole.

The support layer 110 is made of a material having a higher rigidity than the separators 12. The support layer 110 is made of a resin composition including, for example, a polyamide resin, a polyester resin, or a polyolefin resin. In order to increase rigidity, the support layer 110 is preferably made of a resin composition including a polyester resin. More preferably, the support layer 110 is made substantially of a polyester resin. The polyester resin may be, for example, polyethylene terephthalate (PET). This makes it possible to increase the rigidity of the first current collector 100A and to maintain the electrical insulation of the support layer 110. Furthermore, the support layer 110 can be made relatively thin.

A thickness direction DT of the support layer 110 is substantially orthogonal to the first direction D1. That is, the support layer 110 extends in a direction substantially orthogonal to the first direction D1.

In order to reduce the overall thickness of the electrode body 10, the overall thickness of the support layer 110 is, for example, preferably 20 μm or less, more preferably m or less, and even more preferably 10 μm or less. The overall thickness of the support layer 110 is not particularly limited as long as it has a desired rigidity. The thickness of the support layer 110 may be, for example, 2 μm or more.

The first conductive layer 120 is located on one side of the support layer 110 in the thickness direction DT. The first conductive layer 120 includes a first body portion 121 and a first extension portion 122.

The first body portion 121 is laminated on the support layer 110 via the first adhesive layer 130. The first body portion 121 is in direct contact with the first adhesive layer 130. The entire first body portion 121 is in direct contact with the first adhesive layer 130.

The first extension portion 122 extends from the first body portion 121 in a direction orthogonal to the thickness direction DT. The direction in which the first extension portion 122 extends is approximately along the first direction D1.

The first extension portion 122 is laminated on the support layer 110 not via the first adhesive layer 130. The first extension portion 122 is joined to the support layer 110 by ultrasonic welding. A portion of the first extension portion 122 is joined to the support layer 110. The portion of the first extension portion 122 that is joined to the support layer 110 is remote from the first body portion 121. The first extension portion 122 as a whole is not in contact with the first adhesive layer 130. This allows the volume of the first adhesive layer 130 to be reduced, and the weight of the first current collector 100A and the weight of the entire battery 1 to be reduced.

The second conductive layer 140 is located on another side of the support layer 110 in the thickness direction DT. The second conductive layer 140 includes a second body portion 141 and a second extension portion 142.

The second body portion 141 is laminated on the support layer 110 via the second adhesive layer 150. The second body portion 141 is in direct contact with the second adhesive layer 150. The entire second body portion 141 is in direct contact with the second adhesive layer 150.

The second extension portion 142 extends from the second body portion 141 in a direction orthogonal to the thickness direction DT. The direction in which the second extension portion 142 extends is approximately along the first direction D1.

The second extension portion 142 is laminated on the support layer 110 not via the second adhesive layer 150. The second extension portion 142 is joined to the support layer 110 by ultrasonic welding. A portion of the second extension portion 142 is joined to the support layer 110. The portion of the second extension portion 142 that is joined to the support layer 110 is remote from the second body portion 141. The second extension portion 142 as a whole is not in contact with the second adhesive layer 150. This allows the volume of the second adhesive layer 150 to be reduced, and the weight of the first current collector 100A and the weight of the entire battery 1 to be reduced.

The first conductive layer 120 and the second conductive layer 140 are made of a metal. The metal may include aluminum, copper, nickel, stainless steel, and the like. In the embodiment, the first conductive layer 120 and the second conductive layer 140 are made of a metal including aluminum. Accordingly, the first current collector 100A including the first conductive layer 120 and the second conductive layer 140 can be suitably used as a cathode current collector. The first conductive layer 120 may be made substantially of only aluminum. The first current collector 100A may be an anode current collector.

The thickness of each of the first conductive layer 120 and the second conductive layer 140 is less than the thickness of the support layer 110. In order to reduce the overall thickness of the electrode body 10, the thickness of each of the first conductive layer 120 and the second conductive layer 140 is, for example, 5 μm or less, more preferably 2 μm or less, and even more preferably 1 μm or less. The thickness of each of the first conductive layer 120 and the second conductive layer 140 may be, for example, 0.1 μm or more in order to restrain the electrical resistance of each of the first conductive layer 120 and the second conductive layer 140 from becoming too large. In addition, when the thickness of the first conductive layer 120 and the thickness of the second conductive layer 140 are 5 μm or less, it is difficult to directly weld the first conductive layer 120 and the second conductive layer 140 to each other or to directly join them to each other by ultrasonic welding.

The method of forming each of the first conductive layer 120 and the second conductive layer 140 is not particularly limited. These layers are typically made of metal films. The metal films may typically be manufactured by extrusion.

The first adhesive layer 130 and the second adhesive layer 150 are made of, for example, an adhesive. The type of the adhesive is not particularly limited. The adhesive may include an acrylic resin, an olefin resin, a polyimide resin, or ethylene vinyl alcohol (EVA). The materials making up of the first adhesive layer 130 and the second adhesive layer 150 may be the same as or different from each other. The method of providing the first adhesive layer 130 and the second adhesive layer 150 is not particularly limited, and any conventionally known method may be used.

As shown in FIG. 3, the tabs 160 are arranged in a winding direction DR of the electrode body 10. The conductive auxiliary portions 170 are arranged in the winding direction DR of the electrode body 10. The tabs 160 are spaced apart from each other. The conductive auxiliary portions 170 are spaced apart from each other. The conductive auxiliary portions 170 are arranged in a one-to-one correspondence between the tabs 160 and the conductive auxiliary portions 170 in the thickness direction DT.

As shown in FIG. 2, the tabs 160 are arranged in the third direction D3. The tabs 160 are joined to one another, such as by ultrasonic bonding. Furthermore, as shown in FIG. 1, the tabs 160 are joined to the first connecting member 40A, such as by ultrasonic bonding. Accordingly, the first external terminal 30A is electrically connected to the tabs 160. Furthermore, the first external terminal 30A is electrically connected to the first conductive layer 120 and the second conductive layer 140. The configuration of each of the tabs 160 and the configuration of each of the conductive auxiliary portions 170 will be described below.

As shown in FIG. 4, the tab 160 is partially aligned with the first extension portion 122 in the thickness direction DT. The tab 160 extends substantially in the first direction D1 above the first conductive layer 120. The tab 160 is joined to the first extension portion 122 by ultrasonic welding. The tab 160 extends in a direction away from the first conductive layer 120. An extending direction DE in which the tab 160 extends is substantially parallel to the first direction D1. The tab 160 may be directly joined to the first external terminal 30A.

The tab 160 includes a tab body portion 161 and a tab extension portion 162. Both the tab body portion 161 and the tab extension portion 162 are joined to the first extension portion 122 by ultrasonic bonding.

The tab body portion 161 is joined to the first connecting member 40A or another tab body portion 161. The length of the tab body portion 161 in the first direction D1 is longer than that of the tab extension portion 162.

The tab extension portion 162 is not joined to another tab 160 or to the first connecting member 40A. The tab extension portion 162 extends from the tab body portion 161 along the winding direction DR. Providing the tab extension portion 162 makes it possible to make the electrical resistance small in a current path when a current flows from the first conductive layer 120 to the tab 160, and vice versa.

The conductive auxiliary portion 170 is partially aligned with the second extension portion 142 in the thickness direction DT. The conductive auxiliary portion 170 extends substantially in the first direction D1 above the second conductive layer 140. The conductive auxiliary portion 170 is joined to the second extension portion 142 by ultrasonic welding. The conductive auxiliary portion 170 extends in a direction away from the second conductive layer 140. An end of the conductive auxiliary portion 170 in the extending direction DE is joined to the tab 160 by ultrasonic bonding.

The tab 160 and the conductive auxiliary portion 170 are made of a film material. The tab 160 and the conductive auxiliary portion 170 are typically made of a metal film including aluminum, copper, or the like.

The thickness of each of the tab 160 and the conductive auxiliary portion 170 is greater than the thickness of each of the first conductive layer 120 and the second conductive layer 140. The thickness of each of the tab 160 and the conductive auxiliary portion 170 is, for example, preferably 20 μm or less, more preferably 15 μm or less, and even more preferably 10 μm or less. The thickness of each of the tab 160 and the conductive auxiliary portion 170 is not particularly limited as long as it has a desired rigidity. The thickness of each of the tab 160 and the conductive auxiliary portion 170 may be, for example, 2 μm or more.

One of the first active material layers 200A is laminated on the first body portion 121. The one of the first active material layers 200A is laminated on the entire first body portion 121. The one of the first active material layers 200A is not laminated on the first extension portion 122.

The other first active material layer 200A is laminated on the second body portion 141. The other first active material layer 200A is laminated on the entire second body portion 141. The other first active material layer 200A is not laminated on the second extension portion 142.

These first active material layers 200A are cathode active material layers, but may also be anode active material layers. These first active material layers 200A are spaced apart from the tabs 160 and the conductive auxiliary portions 170. The separators 12 are laminated on the first active material layers 200A in a radial direction centered on the winding axis Z.

The first protective portion 400 is made of an electrically insulating ceramic. The first protective portion 400 covers a part of the first active material layer 200A laminated on the first conductive layer 120 on an extending direction DE side. The first protective portion 400 covers the entire surface of the first conductive layer 120 (the first extension portion 122) between the first active material layer 200A and the tab 160. The first protective portion 400 is also partially disposed between the first conductive layer 120 (first extension portion 122) and the tab 160 in the thickness direction DT.

The second protective portion 500 is made of an electrically insulating ceramic. The second protective portion 500 covers a part of the first active material layer 200A laminated on the second conductive layer 140 on the extending direction DE side. The second protective portion 500 covers the entire surface of the second conductive layer 140 (the second extension portion 142) between the first active material layer 200A and the conductive auxiliary portion 170. The second protective portion 500 is also partially disposed between the second conductive layer 140 (second extension portion 142) and the conductive auxiliary portion 170 in the thickness direction DT.

As shown in FIG. 2, the second electrode 11B is laminated on the first active material layer 200A in the radial direction via the separators 12. In the embodiment, the electrode body 10 includes the multiple separators 12, but may include a single separator 12.

The second electrode 11B includes a second current collector 100B and a second active material layer 200B. The second current collector 100B is pulled out from between the second active material layers 200B to one side in the first direction D1. The second current collector 100B is joined to the second connecting member 40B by ultrasonic welding (see FIG. 1).

The second current collector 100B is made of, for example, a metal film. The second current collector 100B is made of, for example, a metal including copper. Accordingly, the second current collector 100B can be suitably used as an anode current collector. When the first current collector 100A is an anode current collector and the second current collector 100B is a cathode current collector, the second current collector 100B may be made of a metal including aluminum. The second current collector 100B may have the same structure as the first current collector 100A.

The second active material layers 200B are laminated on both sides of the second current collector 100B. In the embodiment, the second electrode 11B is an anode. Therefore, the second active material layer 200B is an anode active material layer. The second active material layer 200B may be a cathode active material layer.

As described above, the first current collector 100A according to the embodiment of the present disclosure includes the support layer 110, the first conductive layer 120, the first adhesive layer 130, and the tabs 160. The support layer 110 is made of an electrically insulating resin composition. The first conductive layer 120 includes the first body portion 121 and the first extension portion 122. The first body portion 121 is laminated on the support layer 110 via the first adhesive layer 130. The first extension portion 122 extends from the first body portion 121. The first extension portion 122 is laminated on the support layer 110 not via the first adhesive layer 130. The tabs 160 are each joined to the first extension portion 122.

According to the above configuration, the first extension portion 122 is laminated on the support layer 110 not via the first adhesive layer 130, thereby reducing the effect of the first adhesive layer 130 on the bonding strength between the first extension portion 122 and the tab 160. That is, the effect of the first adhesive layer 130 between the first conductive layer 120 and the support layer 110 on the bonding strength between the first conductive layer 120 and the tab 160 can be reduced.

In the embodiment, the tabs 160 are each joined to the first extension portion 122 by ultrasonic welding. The first extension portion 122 is joined to the support layer 110 by ultrasonic welding.

According to the above configuration, the tab 160, the first extension portion 122, and the support layer 110 can be easily mechanically joined to one another. At this time, since the first adhesive layer 130 is not provided between the first extension portion 122 and the support layer 110, a decrease in the mechanical bonding strength during ultrasonic welding between them is suppressed.

Moreover, the battery 1 according to the embodiment of the present disclosure includes the electrode body 10 and the first external terminal 30A. The electrode body 10 includes the first electrode 11A, the second electrode 11B, and the separators 12. The first electrode 11A includes the first current collector 100A and the first active material layers 200A. The first current collector 100A includes the support layer 110, the first conductive layer 120, the first adhesive layer 130, and tabs 160. The support layer 110 is made of an electrically insulating resin composition. The first conductive layer 120 includes the first body portion 121 and the first extension portion 122. The first body portion 121 is laminated on the support layer 110 via the first adhesive layer 130. The first extension portion 122 extends from the first body portion 121. The first extension portion 122 is laminated on the support layer 110 not via the first adhesive layer 130. The tabs 160 are each joined to the first extension portion 122. The first active material layer 200A is laminated on the first body portion 121. The separator 12 is laminated on the first active material layer 200A. The second electrode 11B is laminated on the first active material layer 200A via the separators 12. The first external terminal 30A is electrically connected to the tabs 160.

According to the above configuration, the first extension portion 122 is laminated on the support layer 110 not via the first adhesive layer 130, thereby reducing the effect of the first adhesive layer 130 on the bonding strength between the first extension portion 122 and the tab 160. That is, the effect of the first adhesive layer 130 between the first conductive layer 120 and the support layer 110 on the bonding strength between the first conductive layer 120 and the tab 160 can be reduced. Furthermore, with the above configuration, it is possible to suppress the first active material layer 200A from slipping off the first body portion 121, which may be triggered by peeling of the first body portion 121 from the support layer 110.

In the embodiment, the first active material layer 200A is not laminated on the first extension portion 122. According to the configuration, the thickness of the laminate including the support layer 110, the first conductive layer 120, and the first active material layer 200A can be made relatively uniform. This is because the difference in thickness caused by the first body portion 121 provided with the first adhesive layer 130 and the first extension portion 122 is not included in the laminate. Furthermore, when the laminate is rolled, it is possible to reduce the occurrence of problems in a rolling device caused by the difference in thickness.

In the embodiment, the first active material layer 200A is laminated over the entire first body portion 121. According to the configuration, the energy density of the battery 1 can be improved while the thickness of the laminate including the support layer 110, the first conductive layer 120, and the first active material layer 200A is made relatively uniform.

In the above description of the embodiment, configurations that can be combined may be combined with each other.

The embodiment disclosed this time should be considered to be illustrative in all respects and not restrictive. The scope of the present disclosure is indicated by the claims rather than the description of the embodiment described above, and it is intended that all changes within the meaning and scope equivalent to the claims are included.

What is claimed is:

1. A current collector comprising:
a support layer;
a conductive layer;
an adhesive layer; and
a tab, wherein
the support layer is made of an electrically insulating resin composition,
the conductive layer includes a body portion and an extension portion,
the body portion is laminated on the support layer via the adhesive layer,
the extension portion extends from the body portion,
the extension portion is laminated on the support layer not via the adhesive layer, and
the tab is joined to the extension portion.

2. The current collector according to claim 1, wherein:
the tab is joined to the extension portion by ultrasonic welding; and
the extension portion is joined to the support layer by ultrasonic welding.

3. A battery comprising:
an electrode body; and
an external terminal, wherein
the electrode body includes a first electrode, a second electrode, and a separator,
the first electrode includes a current collector and an active material layer,
the current collector includes a support layer, a conductive layer, an adhesive layer, and a tab,
the support layer is made of an electrically insulating resin composition,
the conductive layer includes a body portion and an extension portion,
the body portion is laminated on the support layer via the adhesive layer,
the extension portion extends from the body portion,
the extension portion is laminated on the support layer not via the adhesive layer,
the tab is joined to the extension portion,
the active material layer is laminated on the body portion,
the separator is laminated on the active material layer,
the second electrode is laminated on the active material layer via the separator, and
the external terminal is electrically connected to the tab.

4. The battery according to claim 3, wherein the active material layer is not laminated on the extension portion.

5. The battery according to claim 4, wherein the active material layer is laminated on an entirety of the body portion.
